(19) United States
(12) Patent Application Publication
(10) Pub. No.: US 2008/0088288 A1
(43) Pub. Date: Apr. 17, 2008

(54) Time Discrete Control Of A Continuous Quanity

(75) Inventor: Peter Luerkens, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,087

(22) PCT Filed: May 18, 2005
(86) PCT No.: PCT/IB05/51615

§ 371 Date: Nov. 14, 2006

(30) Foreign Application Priority Data
May 19, 2004 (EP) 04102219.5

(51) Int. Cl. G05F 1/44; G05F 1/00

(52) U.S. Cl. 323/282

(57) ABSTRACT

The invention relates to a time discrete control of a continuous quantity (I₁). In order to achieve a higher resolution of the time discrete control and to avoid an unstable control due to low-frequency effects, an artificial, varying disturbance is introduced to at least one signal involved in the time discrete control. A corresponding control circuit is provided with components (10-14) adapted to perform the time discrete control of the continuous quantity (I₁), and in addition with at least one component (20,21) adapted to introduce the artificial, varying disturbance to at least one signal in the control circuit.

The invention relates to a method for improving a time discrete control of a continuous quantity. The invention relates equally to a control circuit comprising components adapted to perform a time discrete control of a continuous quantity, and to a device and an apparatus including such a control circuit.

Many electronic devices or systems require a control of a continuous quantity, for instance of a current which is provided to a particular component.

Nowadays, such continuous quantities are often controlled by means of a time discrete control circuit. Examples of time discrete control circuits are digital controllers with signal processors or programmable logic components. It is an advantage of time discrete control circuits that they are cost efficient. They allow to realize very complex control processes, which cannot be realized in a reliable way with conventional analog circuits. Time discrete control circuits have the disadvantage, though, that they are not able to react at any arbitrary point of time to a deviation of the value of the controlled continuous quantity from the value of a reference signal. Rather, they are only able to react at predetermined instances, referred to as sampling instances. The sampling instances are usually spaced apart by a multitude of a predetermined smallest unit of time, namely the clock period of the system in which the time discrete control circuit is implemented.

In contrast to a conventional control circuit operating on a continuous time scale, deviations of the value of a controlled quantity from the value of a reference signal only result in a response of the time discrete control circuit at the next sampling instance. In the meantime, the control error will accumulate further. In certain control systems, this may result in cyclically repeating control errors, which may in turn lead to a noticeable impairment of the quality of the control. This is particularly true for those control systems having a transfer function with a pole in the origin. The errors are the larger, the longer the clock period is compared to the dynamic of the controlled system.

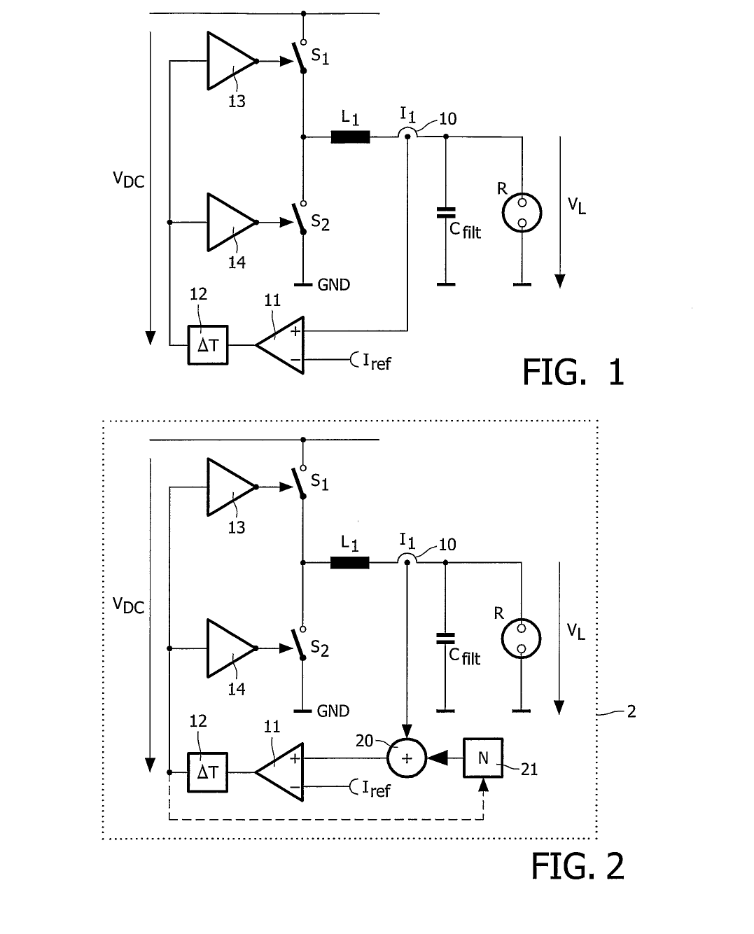

The indicated problem will be illustrated in more detail with reference to FIG. 1. FIG. 1 is a schematic circuit diagram of a power supply module for an ultra-high pressure (UHP) lamp, with a UHP lamp connected to the output of the module.

The power supply module comprises two switching elements S₁, S₂ connected in series between a direct current voltage supply V_{DC} and ground GND. The connection between the two switching elements S₁, S₂ is further connected via a coil L₁ and a capacitor C_{filt} to ground GND. The coil L₁ and the capacitor C_{filt} form a low-pass filter with a certain cut-off frequency. The UHP lamp is connected as a load R in parallel to the capacitor C_{filt} for being provided with a voltage V_{L}. The voltage V_{L} over the load R is to be positive and smaller than the supply voltage V_{DC}. This is achieved by switching the first switching element S₁ and the second switching element S₂ alternately on and off. The filter effect of the capacitor C_{filt} is to be large enough to ensure that the load R will only see a small alternating current. That is, the cut-off frequency of the filter is assumed to lie significantly below the operating frequency of the circuit.

In order to control the switching elements S₁ and S₂ as required, a control circuit is provided. The control circuit comprises a current detector 10, a comparator 11, a delay element 12, a first inverting driver 13 and a second driver 14. The current detector 10 detects the current I₁ through the coil L₁ and provides the resulting measurement value to a first input of the comparator 11. A reference value I_{ref} is input to a second input of the comparator 11. The comparator 11 compares values received at its input and outputs corresponding control signals to the delay element 12. The delay element 12 forwards the control signals with a predetermined delay on the one hand to the first inverting driver 13 and on the other hand to the second driver 14. The first inverting driver 13 controls the first switching element S₁ with an amplified delayed control signal, and the second driver 14 controls the second switching element S2 with an amplified and inverted delayed control signal.

As long as the first switch S₁ is closed and the supply voltage V_{DC} exceeds the voltage across the capacitor C_{filt} and thus as well the voltage V_{L} across the load R, the current I₁ through the coil L₁ will increase. When the comparator 11 detects that the reference value I_{ref} is exceeded by the measurement value representing the current I₁ through the coil L₁, the first switching element S₁ is switched off and the second switching element S₂ is switched on after a predetermined delay ΔT caused by the delay element 12.

The current I_{S1,off} at which this switching occurs is given by the equation:

$${I}_{S 1 , off} = {I}_{ref} + \frac{{V}_{D C} - {V}_{L}}{{L}_{1}} Δ T$$

As a result of the switching, the current I₁ through the coil L₁ will decrease again, until the comparator 11 detects that the reference value I_{ref} exceeds the measurement value representing the current I₁ through the coil L₁ again. After a predetermined delay ΔT caused by the delay element 12, the second switching element S₂ is switched off again and the first switching element S₁ is switched on again.

The current I_{S2,off} at which this switching occurs is given by the equation:

$${I}_{S 2 , off} = {I}_{ref} - \frac{{V}_{L}}{{L}_{1}} Δ T$$

The described switching is repeated continuously, such that the power supply module is operated with a characteristic frequency. This frequency f is given by the equation:

$$f = \frac{1}{Δ T} \frac{{V}_{L}}{{V}_{D C}} ( 1 - \frac{{V}_{L}}{{V}_{D C}} )$$

The control part of such a power supply module can be built in a time discrete manner, for instance by realizing the delay element 12 by means of a counter operating with a fixed clock frequency. This implies, however, that in the most adverse case, the real delay is exactly one clock period t_{c} longer than the desired delay ΔT. This occurs, if the comparator event happens immediately after a sampling instance. This results in errors ΔI_{S1,off}, ΔI_{S2,off} in the true current of maximally:

$$Δ {I}_{S 1 , off} = \frac{{V}_{D C} - {V}_{L}}{{L}_{1}} {t}_{c}$$

$$Δ {I}_{S2 , off} = Δ {I}_{S 1 , off} + \frac{- {V}_{L}}{{L}_{1}} {t}_{c} = \frac{{V}_{D C} - 2 {V}_{L}}{{L}_{1}} {t}_{c}$$

As the currents change on a linear time scale, the average error ΔĪ of the output current can be determined to be:

$$Δ \overline{I} = \frac{1}{2} ( Δ {I}_{S 1 , off} + Δ {I}_{S2 , off} ) = \frac{2 {V}_{D C} - 3 {V}_{L}}{2 {L}_{1}} {t}_{c}$$

This error affects subsequent operating cycles and causes a pattern repeating in time. The characteristic frequency of this pattern depends on the relation between the supply voltage V_{DC} and the voltage V_{L} provided at the output of the power supply module. The characteristic frequency can be so low that the filter properties of the capacitor C_{filt} may not be able to keep it away from the load R. As a result, the remaining ripples in the direct current fed into the load R are increased significantly. It is even possible that the filter resonance frequency is excited which leads to an even more increased current ripple.

The described problem can be attenuated by increasing the clock frequency of the control circuit such that no significant error will result compared to a conventional continuous mode control circuit. Eventually, however, this results in unrealistically high sampling rates, which in turn imply new problems in form of a high current consumption, high costs and a high electromagnetic radiation.

It is an object of the invention to improve the quality of a time-discrete control of a continuous quantity.

A method for improving a time discrete control of a continuous quantity is proposed, which comprises introducing an artificial, varying disturbance to at least one signal involved in the time discrete control.

Further, a control circuit is proposed, which comprises components adapted to perform a time discrete control of a continuous quantity, and in addition at least one component adapted to introduce an artificial, varying disturbance to at least one signal in the control circuit.

Finally, a device comprising such a control circuit and an apparatus comprising such a control circuit are proposed.

The invention is based on the idea that the characteristic frequency of a repeating pattern can be shifted, for example beyond the cut-off frequency of an employed filter, if at least one signal involved in the time discrete control is intentionally disturbed.

It is an advantage of the invention that it allows to improve the quality of the time discrete control, namely to achieve a higher resolution of the control and to avoid an unstable control due to error patterns repeating with a low-frequency, without increasing the clock frequency. Additional costs required for implementing the invention are either minimal or do not occur.

The artificial, varying disturbance can be introduced to various signals involved in the time discrete control and accordingly at various places of a control circuit. The disturbance can be introduced for instance to a signal representing a measured value of the continuous quantity which is to be controlled. Correspondingly, the disturbance can be applied to an input for a measurement value of the proposed control circuit. The disturbance can moreover be introduced for instance to a signal representing a reference value used for detecting a deviation of a value of the continuous quantity from a desired value. Correspondingly, the disturbance can be applied to an input for a reference signal of the proposed control circuit. The disturbance can moreover be introduced for instance to a signal used for adjusting the continuous quantity to a desired value. Correspondingly, the disturbance can be applied to an output of a controlling signal of the control circuit.

The artificial, varying disturbance can further be introduced in various ways. It can be introduced for example by adding a varying disturbing signal to at least one signal involved in the time discrete control. Such a disturbing signal can be generated for instance by means of a noise generator or by means of a pseudo-noise generator. Alternatively, the disturbance can be introduced for example by delaying at least one signal involved in the time discrete control with a varying time delay.

In one embodiment of the invention, the frequency of the artificial disturbance is synchronized with an operating frequency of the time discrete control that is with the frequency at which control signals are provided. This has the advantage that low frequency inter-modulation products can be excluded. If the time discrete control comprises for instance switching at least one switching element for controlling a continuous quantity, a synchronization can be achieved by deriving the varying disturbance from a frequency division of a switching frequency of at least one switching element.

The invention is particularly suited for a case in which the time discrete control is used for switching at least one switching element providing a current to a low pass filter, where this current constitutes the continuous quantity, which is to be controlled. The characteristic frequency of the artificial, varying disturbance is then advantageously set to be higher than a cut-off frequency of the low pass filter and to be lower than a switching frequency of the at least one switching element. Thereby, it can be ensured that the frequency of the disturbance is sufficiently high for being filtered away by the low pass filter, but sufficiently low for avoiding a falsification of the actual control of the continuous quantity.

An offset error due to the artificial, varying disturbance can be avoided by ensuring that the artificial, varying disturbance has an average value of zero.

The invention can be implemented in any time-discrete control system. The proposed control circuit can be implemented for example in any device or apparatus in which a continuous quantity is to be controlled by means of a control circuit operating on a discrete time scale. The apparatus could be for example a projector, while the device could be for example a power supply module for such a projector. The continuous quantity could then be for example a current, which is provided by the power supply module to a projection lamp of the projector.

These and other aspects of the invention will be apparent from and elucidated with reference to the embodiments described hereinafter with reference to the accompanying drawings, of which:

FIG. 1 is a schematic circuit diagram of a relevant part of a conventional power supply module for an UHP lamp, to which an UHP lamp is connected;

FIG. 2 is a schematic circuit diagram of a first embodiment of a relevant part of a power supply module for an UHP lamp in accordance with the invention, to which an UHP lamp is connected;

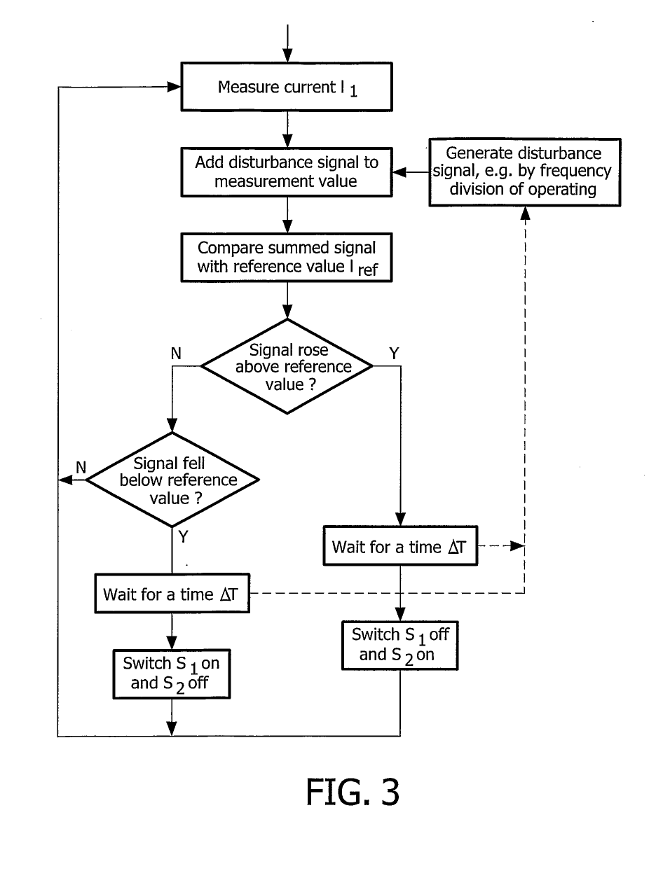

FIG. 3 is a flow chart illustrating the operation of a control part of the power supply module of FIG. 2;

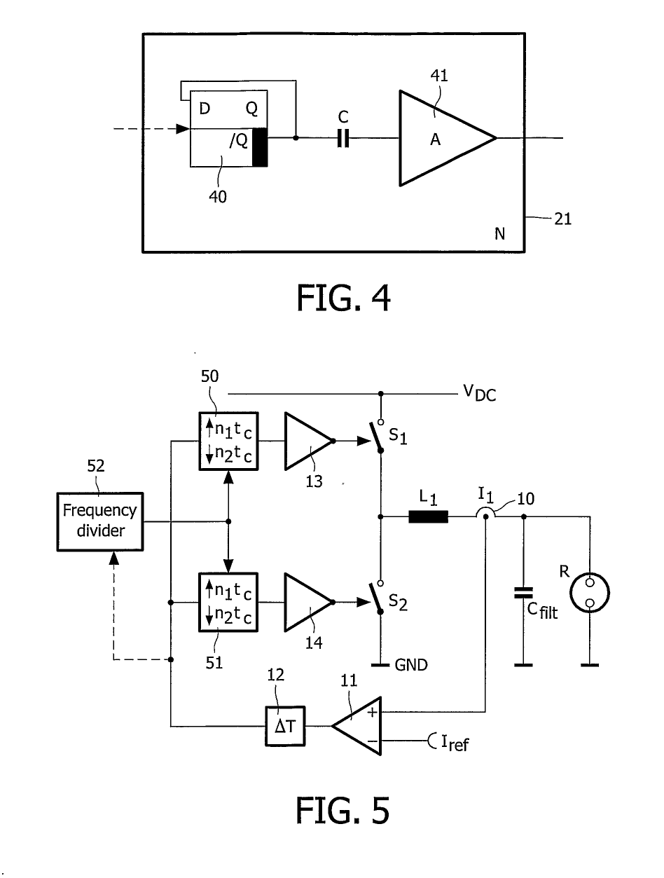

FIG. 4 is a block diagram of an exemplary disturbing signal generator, which can be employed in the power supply module of FIG. 2;

FIG. 5 is a schematic circuit diagram of a second embodiment of a power supply module for an UHP lamp in accordance with the invention, to which an UHP lamp is connected; and

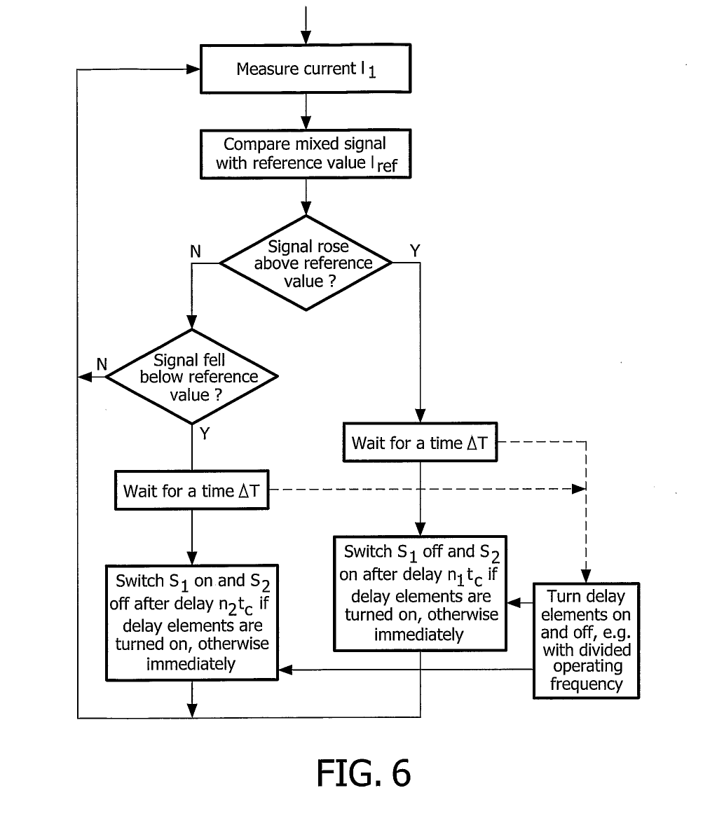

FIG. 6 is a flow chart illustrating the operation of a control part of the power supply module of FIG. 5.

FIG. 2 is a schematic circuit diagram of a system comprising a relevant part of the power supply module for a UHP lamp and a UHP lamp connected to this power supply module. The system may be for instance part of a projector 2 indicated by dotted lines. The power supply module includes a control circuit, which enables a high-quality control in accordance with a first embodiment of the invention.

The power supply module comprises two switching elements S₁, S₂ connected in series between a direct current voltage supply V_{DC} and ground GND. The connection between the two switching elements is further connected via a coil L₁ and a capacitor C_{filt} to ground GND. The UHP lamp is connected as a load R in parallel to the capacitor C_{filt} for being provided with a voltage V_{L}.

The switching elements S₁ and S₂ are controlled by the control circuit of the power supply module. The control circuit comprises to this end a current detector 10, which measures the current I₁ through the coil L₁. The current detector 10 is connected via a summing element 20 to a first input of a comparator 11. A disturbing signal generator N 21 provides a second input to the summing element 20. A reference value I_{ref} is applied to the second input of the comparator 11. The output of the comparator 11 is connected to a delay element 12. The delay element 12 is connected on the one hand to a first inverting driver 13, which has a controlling access to the first switching element S₁ and on the other hand to an second driver 14, which has a controlling access to the second switching element S₂. Optionally, the output of the delay element 12 is further coupled back to a control input of the disturbing signal generator 21, which is indicated in FIG. 2 by a dashed line.

Except for the disturbing signal generator 21 and the summing element 20, the structure of the power supply module is thus the same as in FIG. 1, and the same reference signs are employed for corresponding components.

As in the conventional power supply module, the available direct voltage V_{DC} is downconverted by means of an opposite control of switching elements S₁ and S₂. The resulting current through the coil L₁ is smoothed by the capacitor C_{filt}, so that a positive, direct voltage V_{L} of a required value can be applied to the UHP lamp. The value of the voltage V_{L} can be adjusted by varying the switching ratio. The size of the capacitor C_{filt} is sufficiently large to ensure that a remaining alternating component of the current supplied to the UHP lamp is only small.

The control of the switching elements S₁ and S₂ by means of the control circuit will now be described with reference to FIG. 3.

For controlling the switching elements S₁ and S₂, the current I₁ through the coil L₁ is measured by the current detector 10. In contrast to the conventional system presented with reference to FIG. 1, the measurement value is first provided to the summing element 20, where a disturbing signal provided by the disturbing signal generator 21 is added to the measurement value. In the first embodiment of the invention, thus the summing element 20 and the disturbing signal generator 21 constitute the components of the control circuit which introduce a disturbance to signals involved in the time discrete control.

The comparator 11 now compares the summed value with the reference value I_{ref}. In case the summed value was previously below the reference value I_{ref} and the comparator 11 detects that the summed value rose above the reference value I_{ref}, the comparator 11 outputs a low value. In case the summed value was previously above the reference value I_{ref} and the comparator 11 detects that the summed value fell below the reference value I_{ref}, it outputs a high value. In all other cases, the comparator 11 outputs the same value as before, and the described measuring, summing and comparing is continued without further consequences.

The delay element 12 delays the output of the comparator 11 by a time of approximately ΔT. More specifically, the delay element 12 is a counter, which counts a predetermined number n of clock signals of the system, where t_{c} is the clock period of the system and where ΔT=t_{c}*n. While the actually applied delay can still be larger by up to a period of t_{c}, depending on the triggering instance of the counter, the triggering instance is varied additionally due to the added disturbing signal. The delayed signal is provided to the first inverting driver 13 for amplification of the delayed signal to a suitable value, and to the second driver 14 for amplification of the delayed signal to a suitable value and for inversion. The output of the first inverting driver 13 and the second driver 14 is then used for controlling the switching elements S₁ and S₂.

If the output of a respective driver 13, 14 is high, the associated switching element is switched on or kept switched on, and if the output of a respective driver 13, 14 is low, the associated switching element is switched off or kept switched off.

The characteristic frequency of the disturbing signal provided by the disturbing signal generator 21 to the summing element 20 is selected on the one hand such that it is sufficiently high, in any case higher than the cut-off frequency of the low-pass filter formed by the coil I₁ and the capacitor C_{filt}. On the other hand, the characteristic frequency of the disturbing signal is selected such that it is lower than the actual operating frequency of the power supply module, that is, lower than the resulting switching frequency. Further, the disturbing signal is selected such that its average value is zero, in order to avoid an offset error. These requirements can be met for instance with a noise generator or a pseudo-noise generator. With the proposed characteristic frequency of the disturbing signal, it can be ensured that possible repeating patterns of a low frequency which cannot be filtered away by the low-pass filter formed by the coil L₁ and the capacitor C_{filt} are avoided, while the actual control of the power supply is not affected noticeably due to the filter properties of the coil L₁ and the capacitor C_{filt}.

If the characteristic frequency of the disturbing signal is in addition synchronized to the operating frequency of the system, it is ensured that additional low frequency inter-modulation products are excluded.

FIG. 4 presents by way of example a disturbing signal generator N 21 producing a very simple disturbing signal, which is synchronized to the operating frequency of the power supply module. The disturbing signal generator 21 comprises a back-coupled single edge-triggered D-flipflop 30, a capacitor C and an amplifier 31, connected to each other in series. The disturbing signal generator 21 and thus the flipflop 30 receives as input signal the output signal of the delay element 12, which determines the operating frequency of the power supply module. The flipflop 30 outputs a disturbing signal having a frequency, which is exactly half of the operating frequency of the power supply module. The capacitor C prevents the occurrence of direct current components in the disturbing signal. The amplifier 31 sets a suitable amplitude of the disturbing signal, which should not be too large. The output of the amplifier 31 constitutes the output of the disturbing signal generator 21, which is connected to the summing element 20.

In a similar manner, the reference signal I_{ref} could be mixed with a disturbing signal.

FIG. 5 is a schematic circuit diagram of another system comprising a power supply module for a UHP lamp, and a UHP lamp connected to this power supply module. In this case, the power supply module includes a control circuit, which enables a high-quality control in accordance with a second embodiment of the invention. For this second embodiment, no analog circuit parts are required. Rather, the invention is realized by digital components.

The power supply module comprises again two switching elements S₁ and S₂, a coil L₁ and a capacitor C_{filt}, which are arranged and which operate in exactly the same manner as in the embodiment depicted in FIG. 2. In parallel to the capacitor C_{filt}, moreover a UHP lamp is connected again as a load R.

Further, a current detector 10 measuring the current through the coil L₁ is connected to a first input of a comparator 11, while a reference value I_{ref} is provided to a second input of the comparator 11. The output of the comparator 11 is connected to a first delay element 12. The output of the first delay element 12 is connected on the one hand via a second delay element 50 to a first inverting driver 13, and on the other hand via a third delay element 51 to an second driver 14. Both, the second and the third delay element 50, 51 can be turned on and off. The delay times of the second delay element 50 and of the third delay element 51 are integer multiples of a clock period t_{c} of the system and denoted as n₁t_{c} and n₂t_{c}, respectively. In the current embodiment, it is assumed by way of example that the voltage V_{L} across the load R is to lie in a range of ¼ to ⅓ of the supply voltage V_{DC}. For this special case, advantageous values of nᵢ=1 and n₂=2 have been chosen.

A simple frequency divider 52 has a controlling access to the second and the third delay element 50, 51. The frequency divider 52 is controlled in turn by the output of the first delay element 12.

The control of the switching elements S₁ and S₂ by means of the control circuit will now be described with reference to FIG. 6.

For controlling the switching elements S₁ and S₂, the current I₁ through the coil L₁ is measured by the current detector 10. The measurement value is provided to the comparator 11, and the comparator 11 compares the measured value with the reference value I_{ref}. In case the measurement value was previously below the reference value I_{ref} and the comparator 11 detects that the measurement value rose above the reference value I_{ref}, comparator 11 outputs a low value. In case the measurement value was previously above the reference value I_{ref} and the comparator 11 detects that the measurement value fell below the reference value I_{ref}, the comparator 11 outputs a high value. In all other cases, the comparator 11 outputs the same value as before, and the described measuring, summing and comparing is continued without further consequences.

The delay element 12 delays the output of the comparator by a time ΔT. More specifically, the delay element 12 is a counter, which counts a predetermined number n of clock signals of the system, where t_{c} is the clock period of the system and where ΔT=t_{c}*n. The actually applied delay can still be larger by up to a period of t_{c}, depending on the triggering instance of the counter.

The delayed signal is provided via the second delay element 50 to the first inverting driver 13 for amplification to a suitable value and via the third delay element 51 to the second driver 14 for amplification to a suitable value and for inversion. The actual delay applied by the second delay element 50 and the third delay element 51 depends on the direction of the transition indicated by the output of the delay element 12. In the case of a transition from a low to a high value, the delayed signal is further delayed by n₁ clock cycles, while in the case of a transition from a high to a low value, the delayed signal is further delayed by n₂ clock cycles. The second delay element 50 and the third delay element 51 delay the received signal before forwarding it to the respective driver only in case they are turned on by the frequency divider 52. The output of the first inverting driver 13 and the second driver 14 is used for controlling the switching elements S₁ and S₂. If the output of a respective driver 13, 14 is high, the associated switching element S₁, S₂ is switched on, and if the output of a respective driver 13, 14 is low, the associated switching element S₁, S₂ is switched off.

For controlling the second delay element 50 and the third delay element 51, the frequency divider 52 divides the frequency of the signal provided by the first delay element 12 by a predetermined factor, for instance by two, and turns the second and third delay element 50, 51 in parallel on and off with the resulting divided frequency.

Possible repeating patterns of a low-frequency in the signal output by the first delay element 12 due to its time discrete operation are therefore replaced by a much higher frequency. As a result, the previously very low repetition frequencies are increased significantly and the effective resolution of the current control is improved. Any resulting high repetition frequencies are filtered away by the low-pass filter formed by the coil L₁ and the capacitor C_{filt}.

In the second embodiment of the invention, thus the frequency divider 52, the second delay element 50 and the third delay element 51 constitute the components of the control circuit which introduce a disturbance to signals involved in the time discrete control.

Summarized, all presented embodiments exploit the filter properties of the power supply module to achieve a higher resolution artificially by introducing a disturbance signal. As one consequence, the impact of error patterns repeating with a low frequency is counteracted.

It is understood that the described embodiments of the invention represents only some of a great variety of possible embodiments of the invention. Moreover, reference signs in the claims are not intended to limit the scope of the claims but only to facilitate an easy understanding of the claims. It is further understood that the term “comprising” in the claims does not exclude other elements or steps, and that the terms “a” or “an” in the claims does not exclude a plurality.

1. Method for improving a time discrete control of an continuous quantity (I₁), said method comprising introducing an artificial, varying disturbance to at least one signal involved in said time discrete control.

2. Method according to claim 1, wherein said artificial, varying disturbance is introduced to at least one of a signal representing a measured value of said continuous quantity (I₁), a signal representing a reference value (I_{ref}) which is used for detecting a deviation of a value of said continuous quantity (I₁) from a desired value, and a signal used for adjusting said continuous quantity (I₁) to a desired value.

3. Method according to claim 1, wherein said artificial, varying disturbance is introduced by adding a varying disturbing signal to at least one signal involved in said time discrete control.

4. Method according to claim 3, wherein said varying disturbing signal is generated by means of one of a noise generator or a pseudo-noise generator (21).

5. Method according to claim 1, wherein said artificial, varying disturbance is introduced by delaying at least one signal involved in said time discrete control with a varying time delay (n₁t_{c}, n₂t_{c}).

6. Method according to claim 1, wherein said artificial disturbance is synchronized with an operating frequency of said time discrete control.

7. Method according to claim 1, wherein said time discrete control comprises switching at least one switching element (S₁,S₂) for controlling said continuous quantity (I₁), and wherein said at least one artificial, varying disturbance is derived from a frequency division of a switching frequency of said at least one switching element (S₁,S₂).

8. Method according to claim 1, wherein said time discrete control comprises switching at least one switching element (S₁,S₂) providing a current (I₁) to a low pass filter (L₁,C_{filt}), which current (I₁) constitutes said continuous quantity controlled by said time discrete control, wherein a characteristic frequency of said artificial, varying disturbance is set to be higher than a cut-off frequency of said low pass filter (L₁,C_{filt}) and wherein said characteristic frequency of said at least one artificial disturbing signal is set to be lower than a switching frequency of said at least one switching element (S₁,S₂).

9. Method according to claim 1, wherein said artificial, varying disturbance has an average value of zero.

10. Control circuit comprising components (10-14) adapted to perform a time discrete control of a continuous quantity (I₁), and at least one component (20,21) adapted to introduce an artificial, varying disturbance to at least one signal in said control circuit.

11. Device comprising a control circuit according to claim 10.

12. Device according to claim 11, wherein said device is a power supply module (S₁, S₂, L₁, C_{filt}, 10-14, 20, 21) for providing a predetermined current to a load (R), and wherein said continuous quantity controlled by said control circuit is a current (I₁) provided by said power supply module (S₁, S₂, L₁, C_{filt}, 10-14, 20, 21).

13. Apparatus comprising a control circuit according to claim 10.
Time discrete control of a continuous quantity
